(19) United States
(12) Patent Application Publication
(10) Pub. No.: US 2009/0156351 A1
(43) Pub. Date: Jun. 18, 2009

(54) Hybrid transmission

(76) Inventors: Markus Brouwer, Stuttgart (DE); Benjamin Kaehler, Neunkirchen-Seelscheid (DE); Karl-Ernst Noreikat, Esslingen (DE)

Correspondence Address: Markus Brouwer, Schwabstrasse 33A, Stuttgart, 70197, DE

(21) Appl. No.: 12/288,321

(22) Filed: Oct. 17, 2008

Related U.S. Application Data
(60) Provisional application No. 61/007,772, filed on Dec. 17, 2007.

(51) Int. Cl. F16H 48/22; B60W 10/10; B60W 20/00

(52) U.S. Cl. 475/221; 903/945

(57) ABSTRACT

In a hybrid transmission for a motor vehicle with three differential drive units (D1 to D3), two electric machines (E1, E2) and four shift elements (C1 to C4), the hybrid transmission (HG) includes a fifth shift element (C5) by which two transmission elements of the first differential drive unit (D1) can be coupled thereby achieving an improved operating efficiency and smaller continuous electric power requirements.

### BACKGROUND OF THE INVENTION

The invention concerns a hybrid transmission with differential drive units and two electric machines providing for steplessly variable driving ranges and electric startup of the engine and electric operation of a vehicle.

U.S. Pat. No. 6,551,201 B1 discloses a hybrid transmission wherein three differential drives, two electric machines and four shifting elements are arranged in such a way that three forward gears and four steplessly variable driving ranges are realized.

It is the object of the invention to provide a hybrid transmission with an improved efficiency.

### SUMMARY OF THE INVENTION

In a hybrid transmission for a motor vehicle with three differential drive units (D1 to D3), two electric machines (E1, E2) and four shift elements (C1 to C4), the hybrid transmission (HG) includes a fifth shift element (C5) by which two transmission elements of the first differential drive unit (D1) can be coupled thereby obtaining an improved operating efficiency and smaller continuous electric power requirements.

In accordance therewith, two transmission elements of the first differential drive are interconnectable by a fifth shifting element. When the fifth shifting element is closed, the first differential drive unit rotates as a block.

By way of the fifth shifting element additional forward gears and additional steplessly variable driving ranges can be established.

The arrangement of the steplessly variable driving ranges and the fixed forward gears together with an arrangement of the differential facilitates a substantial reduction of the necessary electric power requirements (continuous requirements).

With the fifth shift element, the ranges requiring a high electrical power within the ranges with double power split can be avoided by shifting to a fixed mechanical forward gear stage.

The fixed mechanical forward gear stages permit an efficient operation under high load. The electric operation is possible in a large speed range, particularly also at higher speeds.

A first one-way clutch unit, via which the transmission input shaft can be coupled with a housing, prevents that the engine is driven by the transmission counter to its direction of operation. Furthermore, during electric operation by means of the second electric machine, an additional moment can be provided by the electric machine via the first one way clutch unit.

Via the second one way clutch unit, the engine can be started without the need for first providing hydraulic pressure.

The invention will become more readily apparent from the following description of a simplified embodiment of the invention on the basis of the accompanying drawings.

### BRIEF DESCRIPTION OF THE DRAWINGS

FIG. 1 shows a schematic gear wheel arrangement of an exemplary embodiment of a hybrid transmission according to the invention, and

FIG. 2 shows a table representing the shifted shifting elements for the respective forward gears or, respectively, steplessly variable operating ranges.

### DESCRIPTION OF A PARTICULAR EMBODIMENT

The invention concerns a hybrid transmission HG, which is preferably used in a motor vehicle and is installed preferably in the longitudinal direction of the vehicle, preferably integrated at least partially in a vehicle body tunnel.

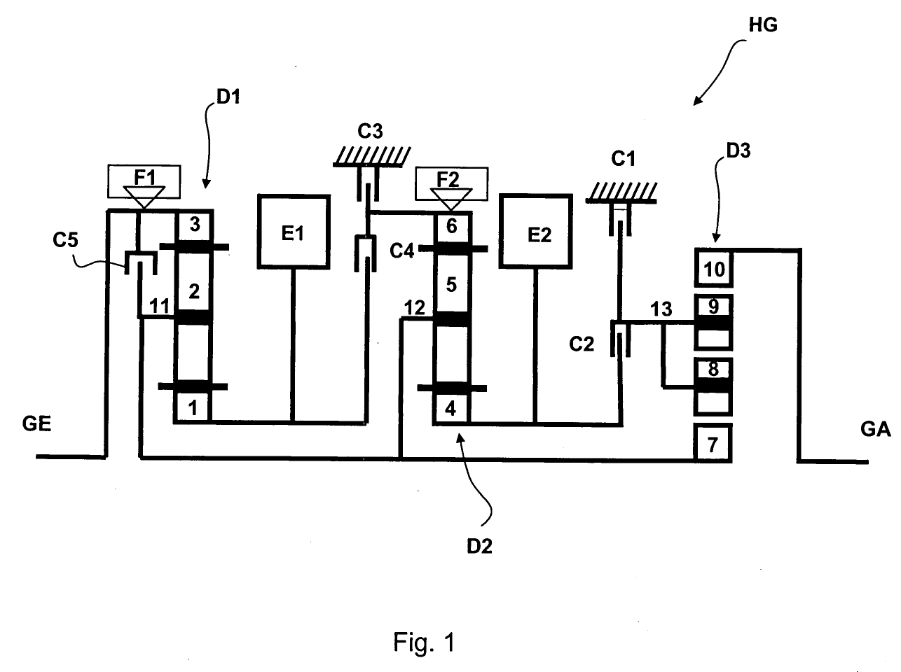

The exemplary embodiment of a hybrid transmission HG as shown in FIG. 1 includes a transmission input shaft GE which is drive-connected to an internal combustion engine and a transmission output shaft GA which is drive-connected to drive wheels of the motor vehicle.

The hybrid transmission HG includes, arranged essentially coaxially in axially subsequent planes:
a fifth shifting element C5 and a first one way clutch unit F1,
a first differential unit D1,
a first electric machine E1
a first shifting element C4 and a third shifting element C3,
a second differential drive unit D2 and a second one way clutch unit F2,
a second electric machine E2,
a second shifting element C2 and a fourth shifting element C1 and,
a third differential unit D3,

all arranged between the transmission input shaft GE and the transmission output shaft GA.

The transmission input shaft GE is drive-connected to a hollow outer gear 3 of the first differential gear unit D1 and can be connected first to a planetary gear carrier 11 of the first differential gear unit D1, a planetary gear carrier 12 of the second differential gear unit D2 and a sun gear 7 of the third differential gear unit D3. The fifth shifting element C5 is preferably a clutch. Alternatively, also two other transmission elements of the first differential gear unit D1 may be connectible via the clutch C5. The planetary carrier 11 of the first differential gear unit D1 supports a planetary gear 2. The planetary gear carrier 12 of the second differential gear unit D2 supports a planetary gear 5.

The transmission input shaft GE can be coupled by means of the first mechanical one way clutch unit F1 to a housing structure in such a way that the internal combustion engine cannot be driven by the transmission input shaft GE in a direction counter to the direction of rotation of the internal combustion engine.

A sun gear 1 of the first differential gear unit D1 is firmly drive-connected the first electric machine E1 and can be connected to a housing section by means of the first shift element C4, which is preferably in the form of a clutch in connection with an outer hollow gear 6 of the second differential gear unit D2 and by means of the third shifting element C3 which is preferably a brake.

The outer gear 6 of the second differential gear unit D2 can be coupled with a housing section by way of the second one way clutch unit F2. The second one way clutch unit F2 is a hydraulic unit activated in such a way that it engages when a pressure drops below a threshold and then acts as a brake. In this way, by the application of a moment of the second electric machine E2, the moment effective at the planet carrier 11 of the first differential D1 can be fixed. This makes it possible to start the internal combustion engine by the first electric machine E1. In this way, the internal combustion engine can be rapidly started by electric energy without the need for a buildup of hydraulic pressure.

A sun gear 4 of the second differential unit D2 is firmly drive-connected to the second electric machine E2 and can be connected to a housing structure by way of the second shift element C2, which is preferably a clutch, in connection with a planet carrier 13 of the third differential unit D3 and via the fourth shift element C1, which is preferably a brake.

The planet carrier 13 of the third differential unit D3 is in the form of a double planet carrier and supports the two planet gears 8 and 9 which are in meshing engagement with each other.

An outer hollow gear 10 of the third differential unit is firmly drive-connected to the transmission output shaft GA.

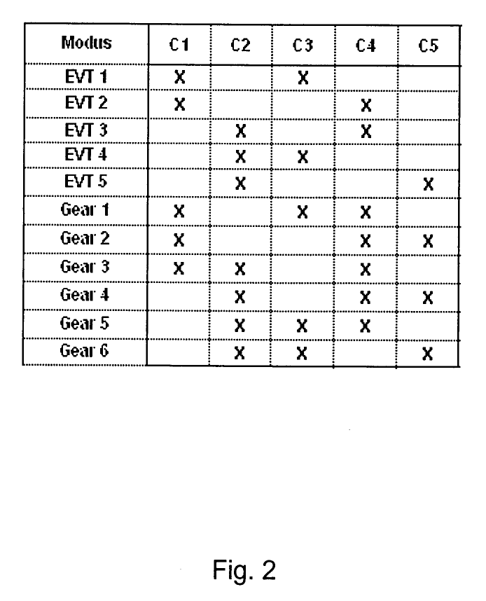

FIG. 2 shows the various modes of operation, namely, six forward gears, gear 1 to gear 6, and five steplessly variable operating ranges EVT1 to EVT5. In the figure, the mark “X” indicates that the respective shift element C1 to C5 is engaged.

The shifting between modes of operation occurs preferably alternatively between a fixed forward gear and steplessly variable operating range.

If, therefore, operation is started in the steplessly variable operating range EVT1 with brakes C1, C3 engaged, the engagement of the clutch C4 results in a shift into the first forward gear 1. Vice versa, the changeover from first gear 1 to the operating range EVT1 occurs by disengagement of the clutch C4.

Next, by releasing the brake C3, a change-over to the steplessly variable operating range EVT2 is obtained. Then, selectively, by closing the clutch C5, the forward gear 2 or by closing the clutch C2, the forward gear 3 can be engaged.

From the forward gear 3, it is possible to change to the steplessly variable operating range EVT3 by releasing the brake C1. From there, it is possible to alternately shift into the forward gear 4 by engaging the clutch C5 or to the forward gear 5 by engaging the brake C3.

From the forward gear 4, it is possible to shift to the steplessly variable operating range EVT5 by disengaging the clutch C4. From the steplessly variable operating range EVT5, it is possible to shift to the forward gear 6 by engaging the brake C3.

From the forward gear 5, it is possible to shift to the steplessly variable operating range EVT4 by opening the clutch C4. From the steplessly variable operating range EVT4, it is possible to shift to forward gear 6 by closing the clutch C5.

What is claimed is:

1. A hybrid transmission for a motor vehicle comprising:
a transmission input shaft (GE) drive-connected to an internal combustion engine, and a transmission output shaft (GA)
three differential drive units (D1, D2, D3) arranged in the power path between the transmission input shaft (GE) and the transmission output shaft (GA)
a first transmission element (outer hollow gear 3) of the differential drive unit (D1) being drive-connected to the transmission input shaft (GE)
a second transmission element (planetary gear carrier 11) of the first differential drive unit (D1) being drive-connected to a first transmission element (planetary carrier 12) of the second differential drive unit (D2) and a first transmission element (sun gear 7) of the third differential drive unit (D3),
a third transmission element (sun gear 1) of the first differential drive unit (D1) being drive-connected to a first electric machine (E1) and drive connectable to a second transmission element (outer hollow gear 3) of the second differential drive unit (D2) via a first shift element (C4),
a third transmission element (sun gear 4) of the second differential being drive-connected to a second electric machine (E2) and drive-connectable to a second transmission element (planetary carrier 13) of the third differential unit (D3) by a second shift element (C2),
a third transmission element (outer hollow gear 10) of the third differential drive unit (D3) drive-connected to the output shaft (GA),
a third shifting element (C3) for connecting the second transmission element (outer hollow gear 6) of the second differential unit (D2) to a housing structure,
a fourth shift element (C1) for connecting the second transmission element (planetary gear carrier 13) of the third differential drive unit (D3) to a housing structure, and
a fifth shift element (C5) for interconnecting the two transmission elements of the first differential drive unit (D1).

2. A hybrid transmission according to claim 1, wherein the first transmission element (outer hollow gear 3) and the second transmission element (planetary gear carrier 11) of the first differential drive unit (D1) are interconnectable via the fifth shift element (C5).

3. A hybrid transmission according to claim 1, wherein a first one way clutch unit (F1) is provided for coupling the transmission input shaft (GE) to a housing structure in such a way that the internal combustion engine cannot be driven via the input shaft (GE) counter to its direction of rotation.

4. A hybrid transmission according to claim 1, wherein a second one way clutch unit (F2) is provided for coupling the second transmission element (outer hollow gear 6) of the second differential drive unit (D2) to a housing structure.

5. A hybrid transmission according to claim 1, wherein six forward gears (gear 1 to gear 6) and five steplessly variable operating ranges (EVT1 to EVT5) are realized.

6. A hybrid transmission according to claim 1, wherein two brakes (C1, C3) and three clutches (C2, C4, C5) are provided as shift elements.
